(19) United States
(12) Patent Application Publication
(10) Pub. No.: US 2026/0366484 A1
(43) Pub. Date: Nov. 19, 2026

(54) DEVICE FOR FASTENING A ROTAR BLADE TO A HUB BODY AND MULTI-PART HUB ASSEMBLY FOR A WIND TURBINE

(71) Applicants: thyssenkrupp rothe erde Germany GmbH, Dortmund (DE); thyssenkrupp AG, Essen (DE)

(72) Inventors: Daniel BECKER, Habichtswald-Ehlen (DE); Marco BURTCHEN, Lippstadt (DE); Matthias TOEFKE, Lippstadt (DE); Wilfried SPINTIG, Lippstadt (DE)

(73) Assignees: thyssenkrupp rothe erde Germany GmbH, Dortmund (DE); thyssenkrupp AG, Essen (DE)

(21) Appl. No.: 19/478,213

(22) PCT Filed: Apr. 22, 2024
(86) PCT No.: PCT/EP2024/060969

§ 371 Date: Oct. 23, 2025

(30) Foreign Application Priority Data
Apr. 24, 2023 (BE) BE 2023/5320
Apr. 24, 2023 (DE) 10 2023 110 410.1

(51) Int. Cl. F03D 1/06; F03D 80/70

(52) U.S. Cl. CPC F03D 1/066; F03D 80/70; F05B 2240/50; F05B 2260/301

(57) ABSTRACT

A device may be used for fastening a rotor blade to a hub body of a wind turbine, with a blade-side extender bearing unit comprising a first bearing ring with a first bolt circle for fastening to the hub body, and a second bearing ring for fastening to the rotor blade, wherein the second bearing ring is arranged rotatably around the common bearing axis coaxially in relation to the first bearing ring, wherein the first bearing ring is formed in one piece with a rotor hub extension, which on the hub side extends in the direction of the bearing axis beyond the second bearing ring and in the hub-side end region of which the first bolt circle is arranged, wherein the device also comprises a hub-side extender bearing unit, which is designed in the form of a plate and has a second bolt circle, wherein the first bolt circle is in line with the second bolt circle for conjoint fastening to the hub body, and also relates to a multi-part hub assembly, which is held together by means of at least one fastening device.

### PRIOR ART

The invention relates to a device for fastening a rotor blade to a hub body according to the preamble of claim 1, and also to a multi-part hub assembly for a wind turbine according to the preamble of claim 6.

The rotor blades of wind turbines are fastened to the hub by means of slewing bearings. The slewing bearings make it possible to adjust the angle of attack of the rotor blades with respect to the wind, which is necessary, among other things, for controlling the power output of the wind turbine.

Usually, the hub bodies are currently designed as one-piece castings. Because the hub body alone can only cope to a limited extent with the ever increasing requirements for the stiffness of the bearing-side connection surfaces in the course of the increase in size of the wind turbines, or to do so have to be of an ever more massive and heavy design, it is known, if need be, for specific, local stiffening of the blade-and/or rotor-bearing connection surfaces, to screw onto the bearing-side attachments additional, separately produced components, such as for example stiffening elements mounted on the blade connection side or hub connection side. These stiffening elements may in a simplified form be made for example as plates with a central hole in the middle, in order to allow access to be gained into the components adjacent to the bearing, i.e. into the hub or into the blade, for assembly and maintenance purposes. The known plates serve primarily for increasing the torsional stiffness of the connection surfaces, in order to relieve the slewing bearings connected to them with regard to the induced structural deformations.

The previous structural design principle with a one-part hub reaches its limits as the power class and size of the wind turbines continues to increase. These limits are on the one hand of a technical production-related nature because in particular, due to the anticipated hub sizes and weights, it is only possible with great production effort to cast such large hub bodies in one piece with the required precision and then machine them with the required high degree of detail. On the other hand, however, the entire wind turbine manufacturing industry is also predictably encountering availability limits, because the number of foundries worldwide that are able to produce such large hub bodies in one piece is a major obstacle to the expected additional construction of wind turbines. Finally, there are also predictably logistical restrictions due to hub transport, in particular for onshore wind turbines, since hub bodies with dimensions above 4 meters can no longer be transported to the site of use by road without significant additional costs as a result of increased transport and traffic management logistics, due to too small bridge heights, tunnel diameters, etc. In the onshore sector, therefore, from a system output of >7-8 MW, it can be expected that one-part hub bodies based on a conventional design of the overall hub-blade bearing system can no longer be transported by road cost-efficiently and therefore practically.

Some concepts according to which the hub body can be divided into a number of smaller parts are therefore already known from the prior art.

For example, EP 2 837 820 B1 describes a segmented wind turbine hub, wherein the segments are formed as hollow bodies and comprise in each case in the hub interior two structurally designed regions with connection surfaces for connecting the segment to two other segments. Each region for connecting the segments has a substantially closed surface area resting on the corresponding surface area of the adjacent segment and fastened to it by bolts, rivets or by means of welding. The symmetrical segmentation takes place here specifically between the blade-bearing connection surfaces, so that the blade bearing ring does not take on any function in terms of structural design for the mechanical fixing of the adjacent hub segments.

U.S. Pat. No. 8,449,263 B2 likewise shows a segmented rotor hub, which is formed in two shells with an inner hub and a hub housing, which are in each case segmented and screwed or riveted to one another via flanges at the segment joints. The inner hub and the hub housing are connected to one another via supporting struts. The segmentation likewise takes place here between the blade-bearing connection surfaces.

It is a disadvantage of the two aforementioned patent specifications that the hub segments, and here in particular the structural elements for fixing adjacent hub segments, are complicated to produce and, in addition to the mounting of the blade bearings that is required in any case, in-volve considerable effort for screwing together the hub segments.

DE 10 2011 052 668 B4 discloses a device for fastening a rotor blade to a hub body according to the preamble of claim 1, and also a hub assembly for a wind turbine according to the preamble of claim 5. DE 10 2011 052 668 B4 describes another segmented hub for a wind turbine. The segments have at least one side which lies against the side of an adjacent segment and extends from an outer circumference of the hub to a central region of the hub. The segments are connected to a front plate which is mounted on the side surfaces of the segments facing in a direction away from the nacelle, i.e. against the direction of the wind. Each rotor blade is fastened to the hub via an additional component, the so-called connecting hub, which has two concentric, circular arrangements of bolt holes. The outer bolt circle is in this case intended for connecting to the hub segments and the inner bolt circle for mounting rotor blade bearings.

A disadvantage is that the connecting hubs must be structurally designed to transfer the load from the blade-side connection diameter to another hub-side connection diameter and, as a result of the two bolt circles, there is significantly increased production and assembly effort. Furthermore, it is a disadvantage that the connecting hub only allows the assembly of rotor blade bearings, and thus of rotor blades, that have a smaller diameter than the larger of the two bolt circles. With regard to the hub size, the full potential of the blade bearing diameter, and thus the blade root diameter, cannot be exploited, which in relation to the smaller blade bearing diameter leads to a reduced load-bearing capacity and service life of the blade bearing. As a consequence of the smaller blade root diameter, this has the overall effect that the rotor diameter is restricted, and therefore the achievable yield of the wind turbine is limited. With the same hub size, only a comparatively small rotor can be supported by the segmented hub. In the known design, however, such a connecting hub, which causes a radial reduction of the maximum blade root diameter, is required, because the usual blade bearings need a continuous, i.e. unsegmented, connection surface. In addition, accessibility to the 2 screw hole circles on the connecting hub—one for fastening the connecting hub on the hub side and one for fastening the connecting hub on the blade side—must be ensured both for mounting and for maintenance purposes at height. The connecting hub has the function of transferring the normal forces and shear forces at the joints of adjacent hub segments in order to protect the fixed rings of the blade bearings from additional transfer of supplementary loads resulting from hub segmentation.

### DISCLOSURE OF THE INVENTION

The object of the invention is therefore to provide a device for fastening a rotor blade to a hub body, and also a multi-part hub assembly for a wind turbine which can be manufactured, transported and assembled on site in a simple manner, and also to provide a higher degree of structural flexibility in terms of the connection diameter of the blade bearing and the rotor blade.

This object is achieved by a device for fastening a rotor blade to a hub body with the features of claim 1 and by a multi-part hub assembly with the features of claim 5.

This provides a device for fastening a rotor blade to a hub body of a wind turbine which comprises a blade-side extender bearing unit and a hub-side extender bearing unit. The blade-side extender bearing unit in this case comprises a first bearing ring with a first bolt circle for fastening to the hub body, and a second bearing ring for fastening to the rotor blade. The second bearing ring is arranged rotatably around the common bearing axis coaxially in relation to the first bearing ring. The hub-side extender bearing unit is designed in the form of a plate and has a second bolt circle. According to the invention it is provided that the first bearing ring is formed with a rotor hub extension, which on the hub side extends in the direction of the bearing axis beyond the second bearing ring and in the hub-side end region of which the first bolt circle is arranged. The second bolt circle of the hub-side extender bearing unit is in line with the first bolt circle of the blade-side extender bearing unit for conjoint fastening to the hub body.

The at least two-part device according to the invention for fastening a rotor blade to a hub body allows the fastening of the rotor blade to a segmented hub body by bolt connections, which extend through the first and second bolt circles and thus at the same time fasten the blade-side extender bearing unit and the hub-side extender bearing unit to the hub body—preferably symmetrically segmented in the blade bearing connection surface. This effectively reduces the number of bolts required, which considerably reduces the assembly effort on site and also at the same time the costs for the machining of the individual components.

This simplified assembly is made possible by the separate formation according to the invention of the blade-side extender bearing unit and the hub-side extender bearing unit. The hub-side extender bearing unit allows the stresses occurring in the joint between hub body segments to be absorbed and thus relieves the blade-side extender bearing unit. The rotor hub extension integrated in the blade-side extender bearing unit is likewise designed in its end region for connection to the hub to absorb the additional stresses arising as a result of segmentation of the hub body. In this way, deformations of the bearing ring arranged on the blade-side extender bearing unit, which could lead to an impairment of the blade bearing, are specifically avoided.

The hub-side extender bearing unit preferably has a plate thickness which is at least 20% of an axial wall thickness of the rotor hub extension in its hub-side end region. Particularly preferably, the plate thickness is at least 50% or even at least 70% of the wall thickness of the rotor hub extension in its hub-side end region. Such plate thicknesses go well beyond the extent of the thicknesses of plate-like stiffening means for stiffening blade connection surfaces of one-part rotor hubs, which only have to absorb torsion stresses on the blade connection surfaces. By contrast, with the aforementioned preferred plate thicknesses, the hub-side extender bearing unit is designed for stresses that are of the same order of magnitude as the stresses introduced into the hub body from the entire rotor blade via the rotor hub extension. Such hub-side extender bearing units are accordingly particularly well suited to absorb the shear forces additionally occurring in the segment joint in the case of a divided hub.

In preferred embodiments, the hub-side extender bearing unit has, in addition to the second bolt circle, fastening means for temporary or permanent fixing of the hub-side extender bearing unit to the hub body. The additional fastening means allow a step-by-step assembly of the device on a multi-part hub body. The fastening means may be formed for example by fastening holes, form-fitting mounting elements or the like. By fixing the hub-side extender bearing unit to the hub body via the fastening means, for example by fixing elements engaging in the fastening holes, a number of hub body segments can be simply and reliably positioned with respect to the hub-side extender bearing unit and relative to one another. This simplifies the assembly of the hub segments and the subsequent assembly of the blade-side extender bearing unit on the already assembled hub body, and in particular reduces possible errors when carrying out assembly on site.

Preferably, at least one row of rolling elements which roll between the first and second bearing rings of the blade-side extender bearing unit and have a rolling element diameter may also be provided, wherein the rotor hub extension extends in the direction of the bearing axis beyond the second bearing ring by at least 3 times the rolling element diameter of the row of the largest rolling elements. The rolling element diameter of the row of rolling elements with the largest diameter is a measure of the maximum forces that can be transferred by the rolling bearing. The tensile forces and shear forces occurring in the joint on a multi-part, segmented hub are directly related to the forces introduced by the rotor blades via the blade bearings. It has been found that the raceway system of the blade bearing is particularly well protected from deformations caused by the forces at the segment joints of the hub if the rotor hub extension extends in the direction of the bearing axis beyond the second bearing ring by at least 3 times the largest rolling element diameter.

In further preferred embodiments, the hub-side extender bearing unit may comprise at least two parts, which include in each case a circumferential portion of the second bolt circle. The multi-part form of the hub-side extender bearing unit has the effect of further reducing the number of components of the size of the blade diameter. In these embodiments, the blade-side extender bearing unit may be the only component of which the dimensions reach or exceed the diameter of the rotor blade to be mounted.

The object is also achieved by a multi-part hub assembly for a wind turbine. The hub assembly comprises a hub body with fastening means for fastening the hub assembly to a nacelle of the wind turbine and at least a third bolt circle for fastening a rotor blade of the wind turbine. The hub body comprises at least two hub body segments, on which in each case a circumferential portion of the third bolt circle is formed. The hub body segments are arranged in such a way that the circumferential portions together form the third bolt circle. The hub assembly also comprises a fastening device according to the invention described above, wherein the third bolt circle is in line with the first bolt circle and the second bolt circle of the fastening device. The fastening device is fastened to the hub body by a plurality of bolts, which extend in each case through the first bolt circle, second bolt circle and third bolt circle.

The conjoint bolt connection of the hub body segments by the multi-part fastening device via the first, second and third bolt circles has the effect of creating between the hub body segments and the fastening device a frictional engagement which transfers the forces occurring in the joint of the hub body segments via the fastening device. The in-line arrangement of all three bolt circles allows easier assembly with only one row of bolts.

The multi-part hub assembly according to the invention achieves a significant reduction in the transport volume to the construction site of the wind turbine in comparison with a one-part hub and at the same time enables simple on-site assembly by means of bolt connections. In addition, the hub body segments can be manufactured with less production effort in comparison with a one-part hub, which can mitigate anticipated bottlenecks in the manufacture of large structural components.

In some preferred embodiments, the third bolt circle is formed as through holes which are arranged in a radial flange of the hub body. The radial flange of the hub body at the same time forms both a stiffening element for the respective hub segment and an enlarged supporting surface for the frictional engagement with the fastening device. Particularly preferably, in these embodiments the hub-side extender bearing unit is arranged on the hub inner side and the blade-side extender bearing unit is arranged on the hub outer side. The sandwich-like arrangement and bolt connection of the radial flanges of adjacent hub segments between the blade-side extender bearing unit and the hub-side extender bearing unit has the effect of further increasing the surface area effective for the frictional engagement, since both axial surfaces of the flange are made usable for the transfer of shear forces and friction forces. Furthermore, in these embodiments the bending stress of the bolt connection which connects the two extender bearing units to the hub segments can be reduced.

In other preferred embodiments, the third bolt circle is formed as blind holes in the hub body, wherein the hub-side extender bearing unit and the blade-side extender bearing unit are arranged on the hub outer side of the hub body. These embodiments are distinguished by a particularly simple casting form for the hub body segments, which are additionally to be provided with only a finely machined supporting surface for the fastening device.

Furthermore, it is advantageous if the circumferential portions of the second bolt circle formed on the parts of the hub-side extender bearing unit are arranged in each case overlapping with at least two circumferential portions of the third bolt circle formed on the hub body segments. In this way, despite in each case at least two-part formation of the hub body and the hub-side extender bearing unit, a transfer of the forces occurring at the joint of the hub body segments via the hub-side extender bearing unit is possible.

Finally, it is advantageous if the hub body segments are connected to one another on the side facing the wind and/or on the side facing away from the wind by at least one stiffening ring. Stiffening rings, in particular seamlessly rolled stiffening rings, are designed to absorb particularly high tensile stresses. In comparison with a screwed-on central plate, a stiffening ring also absorbs the tensile forces further outward in the radial direction, and thus closer to the blade roots, where the loads are introduced into the main body of the hub.

Further advantageous embodiments can be taken from the following description and the de-pendent claims.

The invention will be discussed in more detail below on the basis of the exemplary embodiments shown in the appended figures.

### BRIEF DESCRIPTION OF THE DRAWINGS

FIG. 1 schematically shows a wind turbine of which the rotor blades are mounted on the hub body by means of fastening devices according to the invention,

FIG. 2 schematically shows a hub assembly according to the invention with a three-part hub body and three fastening devices according to the invention,

FIG. 3 schematically shows in a partially sectional, perspective representation parts of the hub assembly according to FIG. 2,

FIGS. 4 and 5 schematically show in sectional representations the interaction of the fastening device and the hub body segments as provided by the exemplary embodiment according to FIGS. 1 to 3,

FIG. 6 schematically shows in a sectional representation the interaction of the fastening device and the hub body segments as provided by a second exemplary embodiment of the invention, and

FIG. 7 schematically shows the second exemplary embodiment according to FIG. 6 in an equipment variant with an electrical blade pitch actuator.

### EMBODIMENTS OF THE INVENTION

In the various figures, the same parts are always provided with the same reference signs and therefore are generally also only referred to or mentioned once in each case.

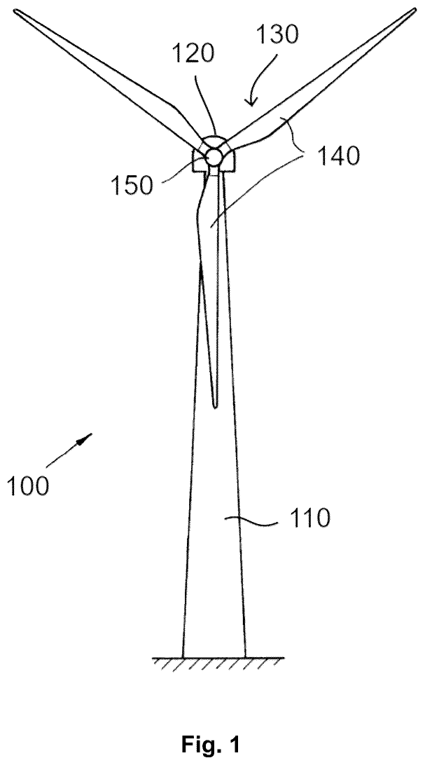

FIG. 1 shows a wind turbine 100 according to the invention. The wind turbine 100 comprises a tower 110, a nacelle 120 and a rotor 130 rotatably mounted on the nacelle 120. The rotor 130 comprises a multi-part hub assembly 150 and a plurality of rotor blades 140 rotatably fastened to the hub assembly 150. Usually, the rotor 130 comprises three rotor blades 140, as shown. The rotor blades 140 are mounted rotatably on the hub assembly 150 to allow the power output of the wind turbine 100 to be controlled in fluctuating wind conditions. In addition, rotor blades 140 can be moved to the feathering position, i.e. in the direction of the wind, in order to minimize the power consumption of the rotor blades 140 and to take the wind turbine 100 out of operation.

At least one of the rotor blades 140 is mounted on the hub assembly 150 by means of a fastening device 1 according to the invention. Preferably, all of the rotor blades 140 are mounted on the hub 150 by means of fastening devices 1 according to the invention.

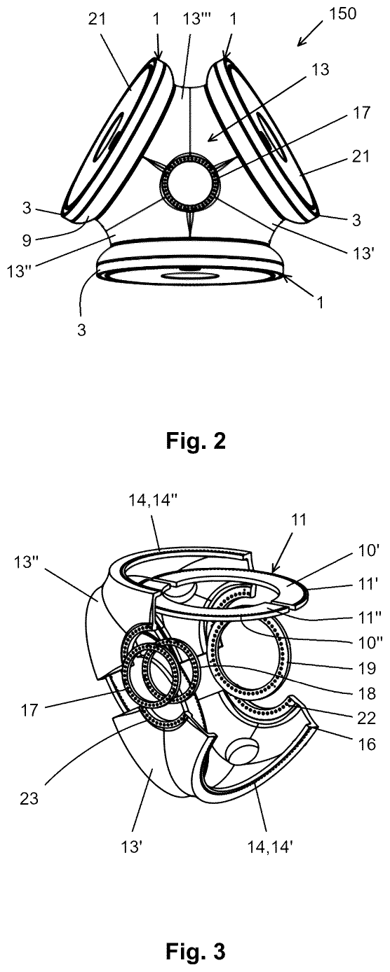

The hub assemblies 150 according to the invention, with the fastening devices 1 used therein for fastening the rotor blades 140 to the hub body, are explained in more detail below with reference to FIGS. 2 to 7.

In FIGS. 2 to 5 there is a first exemplary embodiment of a multi-part hub assembly 150 according to the invention for a wind turbine 100 (cf. FIG. 1). The hub assembly 150 comprises a hub body 13 with fastening means 22 for fastening the hub assembly 150 to the nacelle 120 of the wind turbine 100 and with preferably three third bolt circles 14 for respectively fastening a rotor blade 140 of the wind turbine 100.

The hub body 13 preferably comprises three hub body segments 13′, 13″, 13′″, on which in each case a circumferential portion 14′, 14″ of two of the three third bolt circles 14 is formed. The circumferential portions 14′, 14″ are arranged in such a way that they together form the third bolt circles 14. In other words, the hub body 13 is divided into hub body segments 13′, 13″, 13′″, wherein the joints of the hub body segments 13′, 13″, 13″′ lie in each case in the blade connection surfaces defined by the third bolt circles 14.

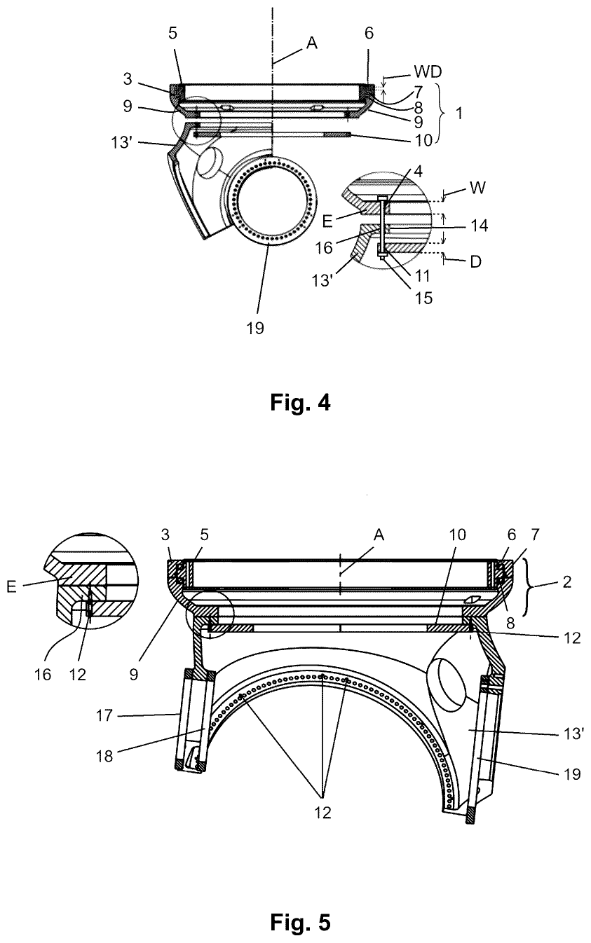

The hub assembly 150 also has for each of the third bolt circles 14 a fastening device 1 according to the invention, which is explained in more detail below with reference to FIGS. 4 and 5.

The fastening device 1 for fastening the rotor blade 140 to the hub body 13 of the wind turbine 100 comprises a blade-side extender bearing unit 2 and a hub-side extender bearing unit 10. The blade-side extender bearing unit 2 has a first bearing ring 3 with a first bolt circle 4 for fastening to the hub body 13 and a second bearing ring 5 for fastening to the rotor blade 140. In this case, the second bearing ring 5 is arranged around the common bearing axis A coaxially in relation to the first bearing ring 3.

The first bearing ring 3 is formed with a rotor hub extension 9, which on the hub side extends in the direction of the bearing axis A beyond the second bearing ring 5. In a hub-side end region E of the rotor hub extension 9, the first bolt circle 4 is arranged. The hub-side end region E is preferably formed as a radially extending flange.

The rotor hub extension may be formed as expanding or reducing substantially cylindrically or conically toward the rotor blade. As a result, rotor blades 140 with different blade root diameters can be mounted on a standardized hub body 13. The fastening device 1 according to the invention accordingly acts as an adapter between standardized components of a modular system.

In the figures, preferred embodiments with a conical expansion of the rotor hub extension 9 toward the rotor blade are shown. Such a conical expansion has the advantage that it is possible with the same size of the hub body 13 to mount larger blade root diameters, and thus also longer rotor blades 140, which allow wind turbines with a higher power output.

The hub-side extender bearing unit 10 is designed in the form of a plate and has a second bolt circle 11. The hub-side extender bearing unit in the form of a plate may have a central opening through which the interior of the rotor blade 140 (see FIG. 1) is accessible from the hub body 13. In the context of this disclosure, in the form of a plate means that the radial extent of the hub-side extender bearing unit 10 is at least three times, preferably at least five times, its plate thickness D.

The plate thickness D of the hub-side extender bearing unit 10 is preferably at least 20% of the axial wall thickness W of the rotor hub extension 9 in its hub-side end region E. In some embodiments, the plate thickness D of the hub-side extender bearing unit 10 may also preferably be at least 50% or even at least 70% of the axial wall thickness W of the rotor hub extension 9 in its hub-side end region E to achieve additional stabilization of the segmented hub body.

According to the invention, it is provided that the second bolt circle 11 is in line with the first bolt circle 4 for conjoint fastening to the hub body 13. The third bolt circle 14 is also likewise in line with the first bolt circle 4 and the second bolt circle 11. The fastening device 1 can therefore be fastened to the hub body 13 by a plurality of bolts 15, which extend in each case through the first bolt circle 4, second bolt circle 11 and third bolt circle 14.

The invention likewise comprises embodiments (not shown) in which at least a second, radially offset set of three bolt circles in line with one another is provided in the hub-side extender bearing unit and the blade-side extender bearing unit, and also the hub body. The additional row of bolt connections can have the effect of increasing the transfer of the loads via the frictional engagement and also the surface area for the clamping of the adjacent hub body segments between the blade-side extender bearing unit and the hub-side extender bearing unit.

As can be seen in particular in FIG. 5, the hub-side extender bearing unit 10 may have in addition to the second bolt circle 11 fastening means 12 for temporary or permanent fixing of the hub-side extender bearing unit 10 to the hub body 13. In a first assembly step, the hub-side extender bearing unit 10 is fastened via the fastening means 12 to the hub body segments 13′, 13″ so that they are correctly positioned in relation to one another. However, the fastening means 12 are not of a type and number sufficient to absorb the loads in the segment joint during operation. Rather, they are aids for simplifying fail-safe assembly. Centering means and/or form-fitting assembly aids for the clear assignment and positioning of the parts may be provided as additional aids for fail-safe assembly. This allows the on-site assembly sequence to be optimized and reduces its complexity.

The first bearing ring 3 and the second bearing ring 5 may be formed for example as a plain bearing with sliding pads.

Preferably, however, at least one row of rolling elements 6, 7, 8 which can roll between the bearing rings 3, 5 and have a largest rolling element diameter WD is provided in addition to or as an alternative to the sliding pads. The rolling elements 6, 7, 8 may be for example balls, cylindrical rollers or tapered rollers. In this case, the rotor hub extension 9 extends in the direction of the bearing axis A beyond the second bearing ring 5 by at least 3 times, more preferably at least 5 times, the largest rolling element diameter WD of the row of the largest rolling elements 7, 8. Due to the axial extent of the rotor hub extension 9, the rotor hub extension 9 has in comparison with a conventional blade bearing ring an additional stiffness, which allows the forces occurring in the segment joint of the hub body segments to be absorbed and to restrict deformations of the raceway system to a tolerable degree.

As shown in FIGS. 2 to 7, the first and second bearing rings 3, 5 may for example form a three-row roller rotary connection. Alternatively, other bearing designs, such as for example a double tapered roller bearing or a double-row angular-contact ball bearing, are however also conceivable. The first and/or the second bearing ring 3, 5 may be divided in the axial direction to simplify the assembly of the bearing. In the exemplary embodiments shown in FIGS. 2 to 7, the outer ring 3 is divided in the axial direction A. However, embodiments in which the inner ring is divided in the axial direction A or there is no division at all in the axial direction A are also conceivable.

As shown in particular in FIG. 3, the hub-side extender bearing unit 10 preferably comprises at least two parts 10′, 10″, which include in each case a circumferential portion 11′, 11″ of the second bolt circle 11. The circumferential portions 11′, 11″ of the second bolt circle 11 formed on the parts 10′, 10″ of the hub-side extender bearing unit 10 are then arranged in each case overlapping with at least two circumferential portions 14′, 14″ of the third bolt circle 14 formed on the hub body segments 13′, 13″.

In addition, the hub body segments 13′, 13″ on the side facing the wind and/or the side facing away from the wind may be connected to one another by means of at least one stiffening ring 17, 18, 19. Preferably, as shown in FIG. 3, two stiffening rings 17, 18, which enclose a flange 23 formed on the hub body segments 13′, 13″ in a sandwich-like manner and are penetrated by a row of bolt connections, are used at least on the side facing the wind. On the side facing away from the wind, the fastening means 22 are preferably likewise formed as a flange with a bolt circle, wherein the stiffening ring 19 is preferably arranged on the inner side of the hub body 13. The flange 22 is then likewise sandwiched in the assembled state by the stiffening ring 19 and the connection component of the nacelle 120, usually a bearing ring of a rotor bearing or a blind flange of a rotor shaft. In this sense, a stiffening ring on the side facing away from the wind may advantageously also be structurally integrated in the rotatable bearing ring of the rotor bearing or the rotor shaft by a correspondingly more massive formation of the rotor bearing ring or the rotor shaft. The stiffening rings 17, 18, 19 are preferably seamlessly rolled rings. The stiffening rings 17, 18, 19 may also be formed as segmented, wherein the ring segment boundaries cover in each case the joints of the hub body segments 13′, 13″.

In the first exemplary embodiment shown in FIGS. 2 to 5, the third bolt circle 14 is formed as through holes which are arranged in a radial flange 16 of the hub body 13. The hub-side extender bearing unit 10 is in this case arranged on the hub inner side of the flange 16 and the blade-side extender bearing unit 2 is arranged on the hub outer side of the flange 16.

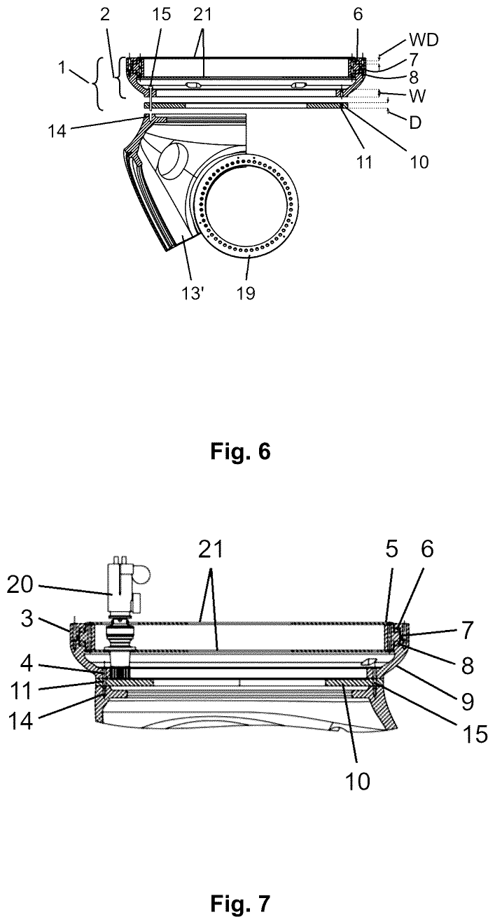

FIG. 6 shows a second exemplary embodiment of the invention. It differs from the first exemplary embodiment shown in FIGS. 2 to 5 in that the third bolt circle 14 is formed as blind holes in the hub body 13. In this case, both the hub-side extender bearing unit 10 and the blade-side extender bearing unit 2 are arranged on the hub outer side of the hub body 13.

Otherwise, the statements relating to the first exemplary embodiment according to FIG. 2 to 5 are correspondingly applicable to the second exemplary embodiment.

FIG. 7 shows an equipment variant of the second exemplary embodiment with an electrical pitch actuator 20. The pitch actuator 20 is integrated in the blade-side extender bearing unit 2. For this purpose, the pitch actuator 20 is mounted on a stiffening plate 21, which for its part is fastened to the second bearing ring 5 of the blade-side extender bearing unit 2. The drive pinion of the pitch actuator 20 is in engagement with a spline in the hub-side end region E of the rotor hub extension 9. In this way, an adjustment of the pitch angle of the connected rotor blade 140 can be made. The integration of the pitch actuator 20 in the fastening device 1 according to the invention has the advantage that the actuator 20 can already be pre-assembled and tested in the factory and the assembly in the field is confined to simple bolt connections for assembling the hub. A separate supply line of the hub and blade bearing unit, including the pitch actuator, is also made possible. Instead of a single pitch actuator 20, it is also possible for a number of pitch actuators 20 to be provided, arranged such that they are distributed over the circumference of the fastening device 1.

The equipment variant with integrated pitch actuator 20 is shown in FIG. 7 by way of example for the second exemplary embodiment. In the same way, the fastening device as provided by the first exemplary embodiment according to FIGS. 2 to 5 may also be equipped with an integrated pitch actuator 20.

### LIST OF REFERENCE SIGNS

1 Fastening device
2 Blade-side extender bearing unit
3 First bearing ring
4 First bolt circle
5 Second bearing ring
6, 7, 8 Rows of rolling elements
9 Rotor hub extension
10 Hub-side extender bearing unit
10′, 10″ Parts of the hub-side extender bearing unit
11 Second bolt circle
11′, 11″ Circumferential portions of the second bolt circle
12 Fastening means
13 Hub body
13′, 13″, 13″′ Hub body segments
14 Third bolt circle
14′, 14″ Circumferential portions of the third bolt circle
15 Bolts
16 Flange
17, 18, 19 Stiffening ring
20 Pitch actuator
21 Stiffening plate
22 Fastening means
23 Flange
100 Wind turbine
110 Tower
120 Nacelle
130 Rotor
140 Rotor blade
150 Multi-part hub assembly
A Bearing axis
E Hub-side end region of the rotor hub extension
D Plate thickness of the hub-side extender bearing unit
W Wall thickness of the rotor hub extension
WD Rolling element diameter

1-11. (canceled)

12. A device for fastening a rotor blade to a hub body of a wind turbine, comprising:
a blade-side extender bearing unit including:
a first bearing ring with a first bolt circle for fastening to the hub body, and
a second bearing ring for fastening to the rotor blade, wherein the second bearing ring is arranged rotatably around the common bearing axis coaxially in relation to the first bearing ring, and
a hub-side extender bearing unit, which is designed in the form of a plate and has a second bolt circle,
wherein the first bearing ring is formed with a rotor hub extension, which on the hub side extends in the direction of the bearing axis beyond the second bearing ring and in the hub-side end region of which the first bolt circle is arranged,
wherein the second bolt circle is in line with the first bolt circle for conjoint fastening to the hub body.

13. The device as claimed in claim 12, wherein the hub-side extender bearing unit has a plate thickness which is at least 20% of an axial wall thickness of the rotor hub extension in its hub-side end region.

14. The device as claimed in claim 12, wherein the hub-side extender bearing unit has a plate thickness which is at least 50% of an axial wall thickness of the rotor hub extension in its hub-side end region.

15. The device as claimed in claim 12, wherein the hub-side extender bearing unit has a plate thickness which is at least 70% of an axial wall thickness of the rotor hub extension in its hub-side end region.

16. The device as claimed in claim 12, wherein the hub-side extender bearing unit has, in addition to the second bolt circle, fastening means for temporary or permanent fixing of the hub-side extender bearing unit to the hub body.

17. The device as claimed in claim 12, wherein at least one row of rolling elements which can roll between the bearing rings and have a rolling element diameter is provided, and the rotor hub extension extends in the direction of the bearing axis beyond the second bearing ring by at least 3 times the rolling element diameter of the row of largest rolling elements.

18. The device as claimed in claim 12, wherein the hub-side extender bearing unit comprises at least two parts, which include in each case a circumferential portion of the second bolt circle.

19. A multi-part hub assembly for a wind turbine, comprising:
a hub body with fastening means for fastening the hub assembly to a nacelle of the wind turbine and at least one third bolt circle for fastening a rotor blade of the wind turbine,
wherein the hub body comprises at least two hub body segments, on which in each case a circumferential portion of the third bolt circle is formed and which are arranged in such a way that the circumferential portions together form the third bolt circle,
wherein the hub assembly also comprises a fastening device as claimed in claim 12,
wherein the third bolt circle is in line with the first bolt circle and the second bolt circle and the fastening device is fastened to the hub body by a plurality of bolts, which extend in each case through the first bolt circle, second bolt circle and third bolt circle.

20. The multi-part hub assembly as claimed in claim 19, wherein the third bolt circle is formed as through holes which are arranged in a radial flange of the hub body.

21. The multi-part hub assembly as claimed in claim 20, wherein the hub-side extender bearing unit is arranged on the hub inner side of the flange and the blade-side extender bearing unit is arranged on the hub outer side of the flange.

22. The multi-part hub assembly as claimed in claim 19, wherein the third bolt circle is formed as blind holes in the hub body, wherein the hub-side extender bearing unit and the blade-side extender bearing unit are arranged on the outer hub side of the hub body.

23. The multi-part hub assembly as claimed in claim 19, wherein the hub-side extender bearing unit comprises at least two parts, which include in each case a circumferential portion of the second bolt circle, and wherein the circumferential portions of the second bolt circle formed on the parts of the hub-side extender bearing unit are arranged in each case overlapping with at least two circumferential portions of the third bolt circle formed on the hub body segments.

24. The multi-part hub assembly as claimed in claim 19, wherein the hub body segments on the side facing the wind and/or the side facing away from the wind are connected to one another by means of at least one stiffening ring.
